(19) United States
(12) Patent Application Publication
(10) Pub. No.: US 2008/0006071 A1
(43) Pub. Date: Jan. 10, 2008

(54) Glycoluril Slow Release Fertilizer Suspension

(76) Inventor: James Harold Williams, Louisville, KY (US)

Correspondence Address: JAMES HAROLD WILLIAMS, 1496 SABLE WING CIRCLE, LOUISVILLE, KY, 40223, US

(21) Appl. No.: 11/456,204

(22) Filed: Jul. 9, 2006

(51) Int. Cl. C05D 9/02

(52) U.S. Cl. 71/27

(57) ABSTRACT

Two methods have been developed for producing a glycoluril slow release fertilizer suspension product. Urea and glyoxal are reacted at a urea to glyoxal mole ratio between 2.0 and 8.0. One or more mineral acids are added between 10 and 30 percent by weight of the formulation and heated between 80 and 100 degrees C. until 70% or more of the glyoxal has been converted to water insoluble glycoluril particles. The pH may be adjusted with an inorganic base, primary fertilizer nutrients added, and a suspending agent is admixed to form a stable suspension. A “green chemistry” method requiring no heat also yields a stable product at room temperature by mixing all the materials and immediately placing the product in storage. The glycoluril product forms during storage in high yield. As such, the liquid glycoluril fertilizer suspensions are stable and easily applied through liquid application, or can be used as a raw material component of a granulated fertilizer product.

### RELATED APPLICATIONS

The present application is related to U.S. Pat. No. 3,061,423, issued Dec. 21, 1959, for GRADUALLY AVAILABLE FERTILIZER COMPRISING GLYCOLURIL, by William Symes, et al.

### FIELD OF THE INVENTION

This invention relates to processes for producing a multi-component glycoluril slow release fertilizer suspension and more particularly, to a process for producing composite fertilizer compositions including nitrogen sources in combination with phosphorus, potassium, secondary nutrient sources and/or mixtures thereof employing a batch reaction or mix to produce the suspension fertilizer compositions from a liquid mixture of urea, mineral acid, glyoxal an inorganic base and a suspending agent.

### BACKGROUND OF THE INVENTION

Slow release fertilizers have become important to gardeners; turf builders and companies that manufacture fertilizer for home care use. Rather than releasing a quick rush of nutrients to the plant as liquid, soluble crystals, or granular fertilizers do, slow release fertilizers release their nutrients slowly over a longer period based on the activity of organisms in the soil.

Slow release fertilizers offer many advantages to the user such as avoiding the common “feast or famine” syndrome that occurs when fast release fertilizers are applied inconsistently. An inconsistent application of a fast release fertilizer surrounds the roots of the plant for a brief period, but is washed away leaving the roots starved. A fast release fertilizer can also be applied in an excessive amount and can thus damage the plant. Slow release fertilizers yield their nutrients out gradually; therefore, both potential problems are minimized or eliminated.

Slow release fertilizers also offer an environmental advantage. In some areas of the country, some pollution has been traced to fertilizers washing through or off lawns and fields into waterways, streams and ground water. The slow release fertilizers are less likely to contribute to this type of pollution since they release their nitrogen nutrients slowly and exhibit low solubility characteristics. The slow release and water insolubility characteristics of this type of fertilizer initially came from thermosetting urea-formaldehyde polymer technology that was used to manufacture molded plastic articles.

Department of Agriculture scientists found, in the late 1940's, that by controlling the degree of polymerization, low molecular weight materials could be formed that were useful as slow release nitrogen fertilizers. The most readily available and economical urea-aldehyde adducts were called ureaforms or urea-formaldehyde condensation products. Ureaform fertilizers are prepared by condensation of an excess of urea with formaldehyde and can be manufactured either as granular or suspension products.

The term ureaform is used in the fertilizer art to denote mixtures of compounds of different degrees of solubility formed by the reaction of urea and formaldehyde under acid conditions when the reaction mixture contains at least 1 mole of urea per mole of formaldehyde. The over all solubility of this material is quite low, and therefore, the product does not form highly concentrated solutions that have a tendency to burn vegetation. In addition to the non-burning advantage of the urea formaldehyde product, the nitrogen within the polymer chain becomes available as a plant nutrient over a prolonged period of time so that unusual heavy applications of the material may be made without damaging or over-feeding plant life.

Urea formaldehyde condensation products containing methylene urea polymers of varying chain length have been widely used, heretofore, as slow release nitrogen fertilizers. Additionally, a variety of processes for producing controlled or slow release fertilizer compositions are known. These processes include producing controlled or slow release reaction products of urea and formaldehyde for fertilizer applications. Traditionally, controlled or slow release urea-formaldehyde reaction products for fertilizer applications have been prepared in order to achieve the proper degree of polymerization required to provide the desired fertilizer characteristics.

Normally, these products have been prepared by first reacting urea and formaldehyde at elevated temperatures in an alkaline solution to produce methylol ureas. The reaction mixtures have then been acidified causing the methylol ureas to polymerize to form methylene urea polymers of varying chain length. Then, in order to produce N—P—K composite granular or suspension fertilizers, further processing steps usually have been required after the reaction step such as: a) formulating additional ingredients with the reacted components and/or granulating the resulting products in a separate granulation step to produce composite granular end products; or b) adding suspending agents to produce products that are sold as suspensions.

Urea formaldehyde polymers have been used for many years in the preparation of fertilizers. In fact, they find utility in all physical types of liquid, suspended solids or suspensions and solid or granular fertilizers.

Liquid plant food compositions have been developed that exhibit high nitrogen composition with methylol ureas as either the final component or the initial reactant. U.S. Pat. No. 4,304,588 to Moore discloses a concentrated UF based solution containing 50% or more of urea in the form of methylolurea.

U.S. Pat. No. 4,579,580 uses uncondensed methylolurea as the starting material to produce a storage stable liquid plant food. Another patent assigned to a major lawn care company (U.S. Pat. No. 4,318,729) is prepared from an aqueous methylol urea solution and dibasic potassium phosphate. The lawn care product is advertised to have approximately 30% nitrogen content from the methylolurea. Other patents, for example, U.S. Pat. Nos. 4,318,729 and 4,579,580 comprise uncondensed methylolurea. In these formulations, aqueous methylol urea containing solutions are mixed with inorganic fertilizer material and diluted with water to the desired composition. A Georgia-Pacific Resins, Inc. patent, U.S. Pat. No. 6,306,194, uses UFC-85 as a reactant with ammonia to produce controlled release urea formaldehyde liquid fertilizer resin with high nitrogen levels.

The second major type of fertilizer, the suspended solids or suspension types have been prepared by the reaction of urea and monomethylolurea in aqueous solution. U.S. Pat. No. 4,578,105, for example, teaches the preparation of an ureaform suspension fertilizer by reacting urea with monomethylolurea in acid solution. The resulting ureaform particles are coated with oil and blended with thickeners to prevent settling.

The current inventor received U.S. Pat. No. 4,530,713 in 1985, which produced a stable ureaform type resin fertilizer suspension by adding urea to an acidic solution of formaldehyde. A two-stage process for preparing a flowable liquid fertilizer containing suspended water insoluble nitrogen was demonstrated in U.S. Pat. No. 4,409,015. U.S. Pat. No. 5,443,613 is another example of a method for producing a suspension fertilizer.

Granular slow release fertilizer compositions are the third type of fertilizer and can also be prepared in various ways. For example, U.S. Pat. No. 5,102,440 was assigned to a major lawn care company that currently sells this formulation as part of its annual fertilizer program. The UF resin composition is sprayed onto finely divided solid particulate raw materials, cooled and solidified to yield an N—P—K fertilizer composition. Another patent (U.S. Pat. No. 4,610,715) discusses the use of mixing an ureaform and selected inorganic materials in a granulator followed by drying and recycling to yield a slow release granulated nitrogen fertilizer.

Another current product assigned to The O. M. Scott & Sons Company, U.S. Pat. No. 4,378,238, uses UFC-85, a precondensed solution of formaldehyde and urea containing substantial amounts of free formaldehyde and dimethylol urea, as a reactant with anhydrous ammonia and water. The solution is then sprayed on vermiculite and inorganic fertilizer material and eventually dried, crushed and screened to yield products that are sold in the Scotts lawn care program.

U.S. Pat. No. 5,102,440 discloses a process, which comprises preparing a mixture of urea and formaldehyde, heating the reaction mixture until essentially all of the formaldehyde in the mixture is fully reacted and a liquid urea-formaldehyde resin is formed. Then, the liquid, fully reacted, urea-formaldehyde resin is sprayed on small, finely divided, solid raw material particles and the urea-formaldehyde resin acts as a binder to agglomerate the solid particles within a matrix formed by the urea-formaldehyde resin in order to produce a granular product of a desired size. The resulting product is allowed to cool and solidify into a hard granular carrier-less product, which exhibits slow release nitrogen properties.

A Boolean search in the “USPTO Patent Full-Text and Image Database” found 603 patents listed for “urea AND formaldehyde AND fertilizer” issued between 1976 and June 2005. The “slow release” patents accounted for 153 patents or 25% of the citations while the granular fertilizer compositions represented 250 patents or 41% of the patents associated with both urea and formaldehyde as their basic raw materials in the formation of the ureaform product.

Environmental and health issues and concerns exist with urea formaldehyde resin systems. One concern is the amount of methylolurea that exists as an impurity in the UF resins. Another concern relates to the amount of free formaldehyde that exists in the resins and the amount of formaldehyde that is emitted during curing and upon cure or final cross-linking.

A manufacturer that produces and uses UF resins also has environmental and health issues. Not only does a manufacturer have to control the formaldehyde emissions during the production or use of UF resins, but must also be aware of the existence of an insolated product called methylolurea. Methylolurea readily hydrolyzes to release formaldehyde. It can also be obtained as a hydrolysis product of methylene diurea, which is one of the components in slow release fertilizer formulations. As an impurity in UF resins, the possibility of environmental exposure to formaldehyde or methylolurea is possible.

A review of toxicological literature was prepared for the National Institute of Environmental Health Sciences, entitled “Methylolurea”. The review article states “the potential exists for occupational exposure to methylolurea or dimethylolurea during the production of UF resins and from the use of any products containing such resins including slow release fertilizers”. Numerous toxicological studies suggest that the toxicity of uncured UF resins containing methylolurea also may be attributed to the presence of formaldehyde. In 2000, methylolurea was listed in the TSCA Inventory.

The slow release of formaldehyde from products containing UF resins is another major concern that has come under close scrutiny by state and federal regulatory agencies. Formaldehyde is considered toxic and a carcinogen. The American Conference of Governmental and Industrial Hygienists has set a formaldehyde ceiling threshold limit value (TLV) of 0.3 ppm, while OSHA has a permissible exposure limit (PEL) of 0.75 ppm and NIOSH has a recommended exposure level (REL) of 0.016 ppm.

Due to these health concerns, much effort has been expended attempting to obtain aldehyde resins with reduced free formaldehyde levels. Additives, such as polyvinyl alcohol, amino acids, and nitro compounds such as nitromethane and wheat gluten proteinaceous material are used to reduce formaldehyde in aldehyde resin systems. The use of melamine and melamine salts, ammonia, urea and sodium sulfite have also been used as scavengers for formaldehyde. However, these materials are used primarily in wood adhesives; the research effort has not addressed resins used in fertilizer products.

Research conducted at the Forest Products Laboratory, USDA Forest Service, has shown that the evolution of formaldehyde from urea formaldehyde materials is incontrovertible. Investigators have examined extensively the structure of components of the UF resin systems and have concluded from these studies that the reactions leading to the formation of the UF products formed during the urea formaldehyde synthesis and cure are reversible. In the forward direction, water is eliminated; therefore, the reverse reactions can be reviewed as hydrolysis, which leads to the release of formaldehyde.

Because most, if not all UF reactions are catalyzed by acids such as ammonium chloride, ammonium sulfate and other acids and acid salts, the use of an inorganic acid-salt catalyst with a UF resin to hasten bond cure unfortunately also increases the rate of hydrolysis and formaldehyde liberation. In UF fertilizer compositions, acid salts, such as the ammonium salts of nitric and phosphoric acid, can also contribute to the hydrolysis of UF derivatives to release formaldehyde.

Granular slow release fertilizer compositions may be prepared by spraying a UF resin onto finely divided solid particulate raw materials, as shown in U.S. Pat. No. 5,102,440. Another method of preparing granular material is by mixing urea, UFC-85 (a precondensed solution of formaldehyde and urea containing substantial amounts of free formaldehyde and dimethylolurea) and anhydrous ammonia reaction products with inorganic materials as described in U.S. Pat. No. 4,378,238.

While the potential for exposure to free formaldehyde or methylolurea may be extremely small or non-existent after application of fertilizers containing UF pre-condensates or polymers, formaldehyde exposure must be controlled at each fertilizer manufacturing facility. There may also exist the potential for free formaldehyde exposure in large warehouses or in the consumer's garage where bags of material containing the UF resin and inorganic acid-salts offer an environment for release of free formaldehyde especially if stored in a moist or damp environment.

The need, therefore, exists for a non-formaldehyde fertilizer compound or particle, which will deliver high doses of slow release nitrogen in dispersed or solid mediums and be cost competitive with UF resin formulations. The present glycoluril suspension fertilizer invention addresses the need for a slow release product with high yields, reasonable cost and no environmental or health issues.

Glycoluril (tetrahydro-imidazo[4,5-d]imidazole-2,5 (1H,3H)-dione) is a term which is used in the fertilizer art to denote a slow release nitrogen compound of low solubility formed by the reaction of urea and glyoxal under acid conditions when the reaction mixture contains at least 2 moles of urea, and preferably more, per mole of formaldehyde. The over all solubility of this material is quite low so that the product does not form highly concentrated solutions that have a tendency to burn vegetation. Moreover, the nitrogen therein becomes available as a plant nutrient over a prolonged period of time so that even heavy applications of the material may be made without damaging or over-feeding plant life. In view of these properties, which make the use of glycoluril in fertilizers highly desirable, fertilizer mixtures have been developed in which the glycoluril is present along with phosphorus and potassium, as well as other more soluble forms of nitrogen.

These products are sold in granular form as shown in U.S. Pat. No. 3,061,423. No one has heretofore proposed to include the glycoluril in liquid fertilizers made by dissolving the more soluble forms of fertilizer components in water. Since liquid fertilizers would have an advantage in that they quickly supply available nutrients to plant life in a form in which it is readily assimilated, liquid mixed fertilizer would be of considerable commercial importance.

It has been found that a stable suspension of glycoluril in a liquid mixed fertilizer can replace the urea-formaldehyde condensation products. One application will provide a supply of quickly available nutrients along with a reserve of slowly available nitrogen and cannot release formaldehyde. Furthermore, the suspended glycoluril particles, upon being applied to the soil or lawn, will remain visible thereon and therefore serve as a visible indicator to show which parts of the area have been sprayed with the liquid fertilizer mixture and which still require treatment.

The high cost of manufacturing glycoluril and the associated low yields are overcome by this inventive method of producing a glycoluril suspension. The cost disadvantage is overcome by a single batch reaction that forms the glycoluril fertilizer product in an aqueous medium. The addition of primary plant nutrients and a suspending agent to the finished product offers a complete liquid mixed fertilizer without additional stages of manufacturing, and therefore, a manufacturing cost advantage. The use of mineral acids in the range of 10 percent to 35 percent by weight has also resulted in high yields of glycoluril. The high yields also contribute to a fertilizer suspension that may be manufactured at a reasonable cost.

This invention, therefore, offers a cost advantage for replacing urea-formaldehyde condensation products with glycoluril due to the high yields and a simple method that can yield a complete N—P—K formulation in a single batch process. Another advantage of this invention is that the glycoluril product does not have the environmental and health problems associated with it, as do urea-formaldehyde condensation products.

### SUMMARY OF THE INVENTION

A storage stable glycoluril suspension fertilizer of the N—P—K type can be prepared by two cost effective and easily controlled methods, whereby urea is reacted with glyoxal in a mineral acid solution to form a suspension of finely divided water insoluble glycoluril particles. The pH may be neutralized and other plant nutrient salts may be added to the water insoluble glycoluril particles, if necessary, to produce a multi-component liquid fertilizer. Thickeners or suspending agents are added to prevent settling of the glycoluril particles.

According to the present invention, the first of two methods for producing a storage stable glycoluril suspension fertilizer comprises heating the reactants using the six or seven steps listed as follows: (1) admixing between 2 and 8 moles of urea per mol of glyoxal in water to form an aqueous solution; (2) acidifying the aqueous solution by adding a mineral acid or a combination of mineral acids to a ratio between 2 to 11 moles of urea per mole of mineral acid or by acidifying the aqueous solution by adding a mineral acid or a combination of mineral acids between 10% to 30% of the total formula weight; (3) maintaining the acidified solution at a temperature between 80 degree and 100 degree Centigrade for one to three hours until the urea and the glyoxal have reacted sufficiently to form a suspension of water insoluble glycoluril particles; (4) cooling and adjusting the pH of the aqueous suspension with potassium hydroxide by adding the acid equivalent moles of base if required in the formulation; (5) adding other plant nutrients if necessary and diluting the suspension with water to a solids level between 35% and 50%; and (6) adding a thickener or suspending agent to prevent the settling of the glycoluril particles.

The second method for producing a storage stable glycoluril suspension fertilizer comprises “green chemistry” where no heating of the reactants is required. The formulation may be prepared by first mixing the ingredients, step 2, and immediately proceeding to step 5 and 6 followed by placing the glycoluril mixture in a storage container. The glycoluril forms in high yield during storage and remains in suspension.

If base is to be added to the “Green Chemistry” method, as shown in Step 4, then the mixture is stirred for 24 to 72 hours as shown in step 7 of FIG. 1, and steps 4 through 6 are then followed to yield the final glycoluril product.

### BRIEF DESCRIPTION OF THE DRAWINGS

A complete understanding of the present invention may be obtained by reference to the accompanying drawing, when considered in conjunction with the subsequent, detailed description, in which:

FIG. 1 is a flow chart of both inventive methods for producing slow release fertilizer suspensions.

For purposes of clarity and brevity, like elements and components will bear the same designations and numbering throughout the figure.

### DESCRIPTION OF THE PREFERRED EMBODIMENT

The method of the present invention may be carried out in a vessel equipped with heating and cooling capability, mechanical stirring, high-speed agitation for incorporation of the suspending material and a water-cooled condenser. No special or unusual equipment is required due of the simplicity of the method.

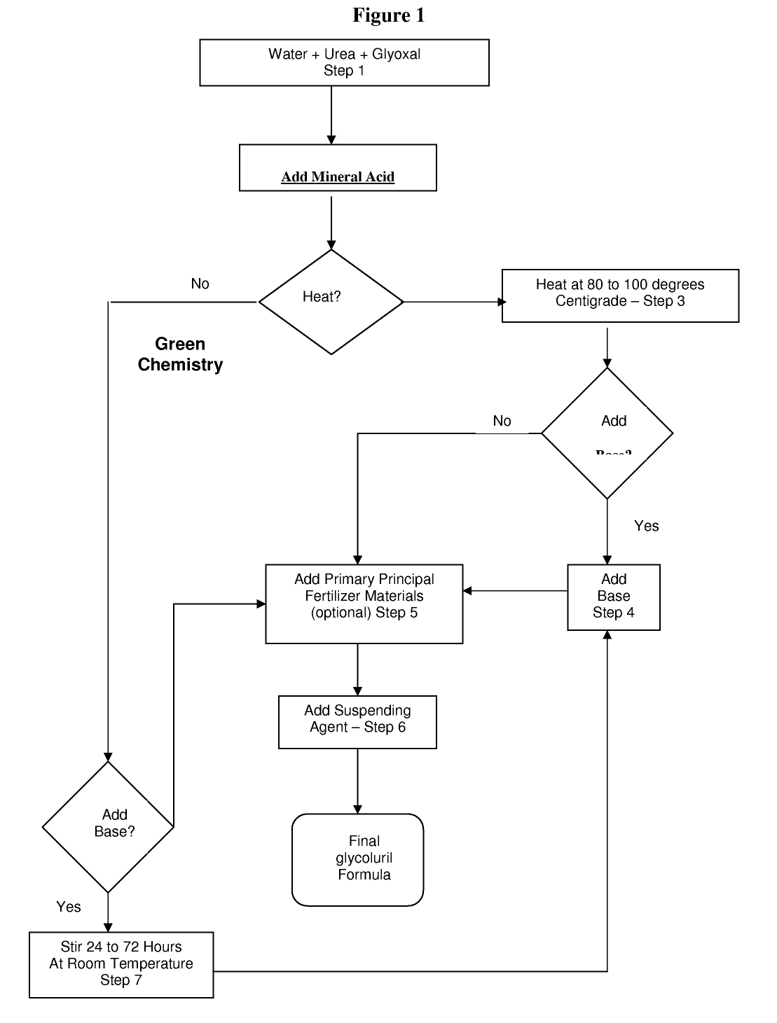

For the method of this invention to be effective in producing a storage stable glycoluril suspension fertilizer, the work method is discussed in the following paragraphs. FIG. 1 shows each of the steps described below.

First, between 2 and 8 moles of urea per mole of glyoxal are dissolved in water to produce an aqueous solution, step 1. The amount of water used will vary depending on the formulated solids content of the final suspension.

Glyoxal can also be slowly added to a urea solution containing the same mole ratios during the heating step 3, however, there is no effect on the yield of the glycoluril suspension. Mixing the two reactants initially and allowing the urea to dissolve completely in water before initiating step 3, simplifies the reaction. Solids content can range between 45 and 65 percent with a recommended 50 percent for a stable suspension formulation.

A 6.0 mole ratio of urea to glyoxal is preferred because the yields are higher. After the theoretical two moles of urea react with glyoxal, the remaining four moles are available to react with the mineral acids, step 2, to form the urea salts of the acids or to remain as free urea nitrogen in the aqueous suspension. Mole ratios between 4.0 and 6.0 can be used. However, urea solubility may become a problem at a mole ratio of 8.0 when formulating solids between 45% and 65%.

The solution is then acidified with a mineral acid or a combination of the acids initiates step 2. The acids used in this invention include: phosphoric (85%); hydrochloric acid (36%); nitric acid (70%). Sulfuric acid can also be used alone or in combination with one or more of the mineral acids to supply the sulfur micronutrient in addition to acting as a catalyst.

An unexpected result of using phosphoric acid and nitric acid is the formation of urea phosphate and urea nitrate solids in the suspension due to the limited solubility of each material in water and the presence of the glycoluril. Both products were isolated and identified as a component of the suspension formulations.

The percentage of acid in the formulation is equal to or greater than 10% by weight and can range from 20% for nitric acid to 30% for phosphoric acid. Those familiar with the art of preparing fertilizer formulations will adjust the acid content to meet the N—P—K formulation requirements.

The glycoluril slow release fertilizer suspension can be prepared with our without heat as shown in FIG. 1. The aqueous urea, glyoxal and acidic solution are heated to a temperature range from, 80 degrees Centigrade to 100 degrees Centigrade initiates step 3. Yields greater than 89% were achieved for all mineral acids (urea/glyoxal ration of 6.0) at reflux for one hour. Reflux times greater than one hour had minimal effect on the yields.

Yields at 80 degrees Centigrade for three hours average 82% for phosphoric and hydrochloric acids, while nitric acid formulations at this same temperature averaged 88%.

A base may be added to the cooled reaction to adjust the pH of the formulation depending on the final N—P—K requirements, step 4 in FIG. 1. Potassium hydroxide (50%) and sodium hydroxide (50%) were used in this discovery. However, bases such as ammonium hydroxide, potassium carbonate and other neutralizing reagents familiar to those knowledgeable in the art of fertilizer formulations may be used. An alternative to adjusting the pH is the direct addition of primary principal fertilizer materials as shown in step 5. The addition of nutrients in this step is optional. Depending on the final N—P—K formulation, principal fertilizer materials such as the ammonium and potassium salts, urea, nitrate salts, phosphate salts, and other multiple nutrients can be added at this stage of the process. Adjustment of solids content with additional water may also be necessary at this step. These nutrients may be added at this step as part of the liquid suspension fertilizer that can be stored for use in the custom lawn treating industry.

The addition of the suspending agent in step 6 is the final step in the process. Attaflow SF, a hydrated aluminum-magnesium silicate product, manufactured by Englehard, was used in this invention. The percentage range of Attaflow SF used was between 0.5% and 1.5%. The most cost effective and preferred amount is 1.0%. Although settling of the glycoluril particles does occur in several days, the particles remain stable, do not agglomerate, and may be resuspended with gentle agitation.

It was also an objective of this discovery to develop a new an novel method of preparing a glycoluril complete fertilizer formulation in a more cost effective and efficient manner at room temperature.

An unexpected and environmentally friendly, “green chemistry”, aspects of this invention are the high yields achieved without heat. If base is to be added to adjust the final pH and nutrient content, the solution of urea and glyoxal in step 2 is first stirred for 24 or 72 hours, step 7, and then the based is added in step 4. Yields of glycoluril at room temperature, with 72 hours stirring, averaged 89%. A high of 94% was achieved for phosphoric acid with the urea/glyoxal ratio of 6.0. Room temperature yields at 24 hours under the same conditions averaged 70% for the mineral acids.

The preferred final pH for this green chemistry method is between 6.5 and 7.2 when bases selected from a group consisting of ammonia, alkali metal hydroxides or alkali metal carbonates are used. Potassium hydroxide is the preferred base of choice since the potassium salt of the acid is an active nutrient in the final formulation.

The optional addition of primary fertilizer nutrients can be added directly to the room temperature solution after step 4. Depending on the final N—P—K formulation, principal fertilizer materials such as the ammonium and potassium salts, urea, nitrate salts, phosphate salts, and other multiple nutrients can be added at this stage of the process. Adjustment of solids content with additional water may also be necessary at this step. These nutrients may be added at this step as part of the liquid suspension fertilizer that can be stored for use in the custom lawn treating industry.

The process for suspending the glycoluril in the green chemistry method, step 6, is the same as described above for the alternative heating method. Attaflow SF, a hydrated aluminum-magnesium silicate product, manufactured by Englehard, was used. The percentage range of Attaflow SF used was between 0.5% and 1.5%. The most cost effective and preferred amount is 1.0%. Although settling of the glycoluril particles does occur in several days, the particles remain stable, do not agglomerate, and may be resuspended with gentle agitation.

The green chemistry method, with no pH adjustment, offers a large cost savings opportunity for manufacturing a glycoluril slow release suspension formulation. The various components of the fertilizer formula are mixed and brought into solution, step 2, primary nutrients may be added in step 5 followed by the suspending agent in step 6, with required agitation. The final suspension formula can then be immediately placed in an appropriate storage container where the glycoluril forms in good yield at room temperature. The suspending agent keeps the glycoluril in suspension as it is formed over time.

After the suspending agent is added in step 6 and effectively mixed with high speed stirring or high speed agitation to yield a stable suspension product in either the heating method or the green chemistry method, the completed formulation offers the combined advantage of both mineral water soluble nitrogen fertilizers and organic water insoluble slow release nitrogen sources for turf applications. The final formulations can also be added as a component to a granular fertilizer. The glycoluril suspension can be sprayed directly onto finely divided particulate raw materials that will be further processed into a granular fertilizer with a slow release component. Various fertilizer manufacturers sell the granulated products with water insoluble nitrogen compounds through their retail outlets.

### EXAMPLES

Examples 1 thru 4 demonstrate the heating method and the use of phosphoric, hydrochloric, nitric and a combination of two acids, phosphoric and nitric acid, respectively to produce formulations with various slow release fertilizer suspension formulations.

### Example 1

A typical slow release fertilizer suspension containing N, P and K in a ratio of 18-7-0, calculated as N—P₂O₅—K₂O is prepared by adding 72.5 grams urea and 52 grams water to a 250-milliliter round bottom flask, equipped with a magnetic stirring bar, a heating mantel and a magnetic stirrer. After the urea dissolved, 29.2 grams glyoxal (40%) was added to the stirred solution followed by 23 grams phosphoric acid (85%). A water-cooled condenser was added to the flask and the voltage set to allow the reaction to reflux for one hour with constant stirring.

The reaction was allowed to cool to room temperature after the one-hour reflux. The cooled mixture was transferred to a 400-milliliter beaker and 10 grams Attaflow SF (20%) were added, followed by high-speed agitation with a Sunbeam hand held Oster Model 2614-000 blender for 5 minutes to yield the stable suspension. The final formulation contained the following plant nutrients: 16.89% urea, 20.52% urea phosphate and 14.09% glycoluril. The final pH was 1.0 and solids were calculated at 52.57%.

### Example 2

A typical slow release fertilizer suspension containing N, P and K in a ratio of 20-0-0, calculated as N—P₂O₅—K₂O is prepared by adding 72.5 grams urea and 35 grams water to a 250-milliliter round bottom flask, equipped with a magnetic stirring bar, a heating mantel and a magnetic stirrer. After the urea dissolved, 29.2 grams glyoxal (40%) was added to the stirred solution followed by 20.0 grams hydrochloric acid (36%). A water-cooled condenser was added to the flask and the voltage set to allow the reaction to reflux for one hour with constant stirring.

The reaction was allowed to cool to room temperature after the one-hour reflux. The cooled mixture was transferred to a 400-milliliter beaker and 10 grams Attaflow SF (20%) were added, followed by high-speed agitation with a Sunbeam hand held Oster Model 2614-000 blender for 5 minutes to yield the stable suspension. The final formulation contained the following plant nutrients: 30.45% urea and 15.44% glycoluril. The final pH was 1.0 and solids were calculated at 51.46%.

### Example 3

A typical slow release fertilizer suspension containing N, P and K in a ratio of 20-0-0, calculated as N—P₂O₅—K₂O is prepared by adding 72.5 grams urea and 50 grams water to a 250-milliliter round bottom flask, equipped with a magnetic stirring bar, a heating mantel and a magnetic stirrer. After the urea dissolved, 29.2 grams glyoxal (40%) was added to the stirred solution followed by 34.0 grams nitric acid (70%). A water-cooled condenser was added to the flask and the voltage set to allow the reaction to reflux for one hour with constant stirring.

The reaction was allowed to cool to room temperature after the one-hour reflux. The cooled mixture was transferred to a 400-milliliter beaker and 10 grams Attaflow SF (20%) were added, followed by high-speed agitation with a Sunbeam hand held Oster Model 2614-000 blender for 5 minutes to yield the stable suspension. The final formulation contained the following plant nutrients: 13.91% urea, 24.93% urea phosphate and 13.00% glycoluril. The final pH was 1.0 and solids were calculated at 52.93%.

### Example 4

A typical slow release fertilizer suspension containing N, P and K in a ratio of 19-4-0, calculated as N—P₂O₅—K₂O is prepared by adding 72.5 grams urea and 50 grams water to a 250-milliliter round bottom flask, equipped with a magnetic stirring bar, a heating mantel and a magnetic stirrer. After the urea dissolved, 29.2 grams glyoxal (40%) was added to the stirred solution followed by 10.0 grams nitric acid (70%) and 12.0 grams phosphoric acid (85%). A water-cooled condensor was added to the flask and the voltage set to allow the reaction to reflux for one hour with constant stirring.

The reaction was allowed to cool to room temperature after the one-hour reflux. The cooled mixture was transferred to a 400-milliliter beaker and 10 grams Attaflow SF (20%) were added, followed by high-speed agitation with a Sunbeam hand held Oster Model 2614-000 blender for 5 minutes to yield the stable suspension. The final formulation contained the following plant nutrients: 20.43% urea, 8.96% urea phosphate, 7.81% urea nitrate and 14.01% glycoluril. The final pH was 1.0 and solids were calculated at 52.34%.

Examples 5 thru 8 demonstrate the heating method, the use of phosphoric, hydrochloric, nitric and a combination of two acids, phosphoric and nitric acid, respectively, and the use of potassium hydroxide as the base for pH adjustment and primary nutrient to produce formulations with various slow release fertilizer suspension formulations.

### Example 5

A typical slow release fertilizer suspension containing N, P and K in a ratio of 16-6-4, calculated as N—P₂O₅—K₂O is prepared by adding 72.5 grams urea and 52.0 grams water to a 250-milliliter round bottom flask, equipped with a magnetic stirring bar, a heating mantel and a magnetic stirrer. After the urea dissolved, 29.2 grams glyoxal (40%) was added to the stirred solution followed by 23.0 grams phosphoric acid (85%). A water-cooled condenser was added to the flask and the voltage set to allow the reaction to reflux for one hour with constant stirring.

The reaction was allowed to cool to room temperature after the one-hour reflux. The pH was adjusted to 6.2 with 25.0 grams potassium hydroxide (45%). After the pH adjustment, the mixture was transferred to a 400-milliliter beaker and 10 grams Attaflow SF (20%) were added, followed by high-speed agitation with a Sunbeam hand held Oster Model 2614-000 blender for 5 minutes to yield the stable suspension. The final formulation contained the following plant nutrients: 24.0% urea, 12.83% potassium dihydrogen phosphate and 12.16% glycoluril. Solids were calculated at 48.8%.

### Example 6

A typical slow release fertilizer suspension containing N, P and K in a ratio of 18-0-5, calculated as N—P₂O₅—K₂O is prepared by adding 72.5 grams urea and 30.0 grams water to a 250-milliliter round bottom flask, equipped with a magnetic stirring bar, a heating mantel and a magnetic stirrer. After the urea dissolved, 29.2 grams glyoxal (40%) was added to the stirred solution followed by 20.0 grams hydrochloric acid (36%). A water-cooled condenser was added to the flask and the voltage set to allow the reaction to reflux for one hour with constant stirring.

The reaction was allowed to cool to room temperature after the one-hour reflux. The pH was adjusted to 6.1 with 25.0 grams potassium hydroxide (45%). After the pH adjustment, the mixture was transferred to a 400-milliliter beaker and 10 grams Attaflow SF (20%) were added, followed by high-speed agitation with a Sunbeam hand held Oster Model 2614-000 blender for 5 minutes to yield the stable suspension. The final formulation contained the following plant nutrients: 27.22% urea, 8.01% potassium chloride and 13.79% glycoluril. Solids were calculated at 49.01%.

### Example 7

A typical slow release fertilizer suspension containing N, P and K in a ratio of 16-0-8, calculated as N—P₂O₅—K₂O is prepared by adding 72.5 grams urea and 50.0 grams water to a 250-milliliter round bottom flask, equipped with a magnetic stirring bar, a heating mantel and a magnetic stirrer. After the urea dissolved, 29.2 grams glyoxal (40%) was added to the stirred solution followed by 34.0 grams nitric acid (70%). A water-cooled condenser was added to the flask and the voltage set to allow the reaction to reflux for one hour with constant stirring.

The reaction was allowed to cool to room temperature after the one-hour reflux. The pH was adjusted to 6.0 with 50.0 grams potassium hydroxide (45%). After the pH adjustment, the mixture was transferred to a 400-milliliter beaker and 10 grams Attaflow SF (20%) were added, followed by high-speed agitation with a Sunbeam hand held Oster Model 2614-000 blender for 5 minutes to yield the stable suspension. The final formulation contained the following plant nutrients: 27.22% urea, 16.31% potassium nitrate and 10.48% glycoluril. Solids were calculated at 47.64%.

### Example 8

A typical slow release fertilizer suspension containing N, P and K in a ratio of 16-6-4, calculated as N—P₂O₅—K₂O is prepared by adding 72.5 grams urea and 52.0 grams water to a 250-milliliter round bottom flask, equipped with a magnetic stirring bar, a heating mantel and a magnetic stirrer. After the urea dissolved, 29.2 grams glyoxal (40%) was added to the stirred solution followed by 12.0 grams phosphoric acid (85%) and 10.0 grams nitric acid (70%). A water-cooled condenser was added to the flask and the voltage set to allow the reaction to reflux for one hour with constant stirring.

The reaction was allowed to cool to room temperature after the one-hour reflux. The pH was adjusted to 6.2 with 28.0 grams potassium hydroxide (45%). After the pH adjustment, the mixture was transferred to a 400-milliliter beaker and 10 grams Attaflow SF (20%) were added, followed by high-speed agitation with a Sunbeam hand held Oster Model 2614-000 blender for 5 minutes to yield the stable suspension. The final formulation contained the following plant nutrients: 24.00% urea, 6.69% potassium dihydrogen phosphate, 5.58% potassium nitrate and 12.16% glycoluril. Solids were calculated at 48.8%.

Example 9 demonstrates the heating method, the use of phosphoric acid, pH adjustment with potassium hydroxide and the addition of monoammonium phosphate and potassium chloride as additional nutrients to produce a slow release fertilizer suspension formulation.

### Example 9

A typical slow release fertilizer suspension containing N, P and K in a ratio of 12-8-8, calculated as N—P₂O₅—K₂O is prepared by adding 72.5 grams urea and 52.0 grams water to a 250-milliliter round bottom flask, equipped with a magnetic stirring bar, a heating mantel and a magnetic stirrer. After the urea dissolved, 29.2 grams glyoxal (40%) was added to the stirred solution followed by 23.0 grams phosphoric acid (85%). A water-cooled condenser was added to the flask and the voltage set to allow the reaction to reflux for one hour with constant stirring.

The reaction was allowed to cool to room temperature after the one-hour reflux. The pH was adjusted to 6.2 with 24.0 grams potassium hydroxide (45%). After the pH adjustment, 16 grams monoammonium phosphate and 24 grams potassium chloride were added to the mixture. An additional 40 grams of water were added to adjust the final solids to 50.8%. The mixture was stirred for 15 minutes and transferred to a 400-milliliter beaker and 15 grams Attaflow SF (20%) were added, followed by high-speed agitation with a Sunbeam hand held Oster Model 2614-000 blender for 5 minutes to yield the stable suspension. The final formulation contained the following plant nutrients: 24.54% urea, 9.18% potassium dihydrogen phosphate, 5.41% monoammonium phosphate, 8.12% potassium chloride and 9.67% glycoluril.

Example 10 demonstrates a cost effective method using “green chemistry”, where no heat energy is required, and the simple mixing of phosphoric acid, along with the addition of potassium nitrate and potassium chloride produce a slow release fertilizer suspension formulation at room temperature.

### Example 10

A typical slow release fertilizer suspension containing N, P and K in a ratio of 18-0-4, calculated as N—P₂O₅—K₂O is prepared by adding 72.5 grams urea, 65.0 grams water and 34 grams nitric acid (70%) respectively, to a 400-milliliter beaker equipped with a magnetic stirring bar. Urea nitrate formed immediately and the mixture was stirred for 30 minutes to dissolve the urea and some urea phosphate. After the urea dissolved, 29.2 grams glyoxal (40%) was added to the stirred mixture and stirring was continued for 10 minutes at room temperature.

Potassium nitrate, 20.0 grams, was added to the mixture and stirring was continued for 15 minutes. Attaflow SF (20%), 15 grams, was added, followed by high-speed agitation with a Sunbeam hand held Oster Model 2614-000 blender for 5 minutes to yield the stable suspension. The final formulation contained the following plant nutrients: 11.48% urea, 8.67% potassium nitrate, 21.15% urea phosphate and 11.40% glycoluril. Solids were calculated at 53.57%.

Liquid glycoluril slow release suspension fertilizers, prepared by the methods above, were bottled and allowed to set on the laboratory shelf for over six months without any sign of gelling or precipitation. Although settling of the glycoluril particles does occur in several days, the particles remain stable, do not agglomerate, and may be resuspended with gentle agitation.

While the compositions and methods described herein constitute preferred embodiments of the invention, it is to be understood that the invention is not limited to these precise compositions and methods, and that changes may be made in either without departing from the scope of the invention, which is defined in the appended claims.

Since other modifications and changes varied to fit particular operating requirements and environments will be apparent to those skilled in the art, the invention is not considered limited to the examples chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of preparing a glycoluril slow release fertilizer suspensions for a liquid application to a lawn or as a component of a granulated fertilizer turf product, the steps comprising:
preparing an aqueous urea glyoxal solution;
acidifying the aqueous solution by the addition of a composition comprising one or more mineral acids selected from a group of hydrochloric, phosphoric, nitric and sulfuric acids to form an acidified solution;
heating the acidified solution until water-insoluble glycoluril particles are formed;
admixing a first composition with the particles wherein said first composition comprises a base selected from the group: ammonia, alkali metal hydroxides and alkali metal carbonates;
admixing principal fertilizer materials with the glycoluril particles and adjusting the water content of the aqueous solution; and
adding a suspending agent for suspending the glycoluril particles;
whereby a formulation at room temperature is formed.

2. The method of preparing glycoluril slow release fertilizer suspension in accordance with claim 1, wherein said aqueous urea and glyoxal solution comprises between 2 and 8 moles of urea per mole of glyoxal.

3. The method of preparing glycoluril slow release fertilizer suspension in accordance with claim 1, wherein said mineral acid is present in an amount of between 10 and 30 percent by formula weight of the mineral acids.

4. The method of preparing glycoluril slow release fertilizer suspension in accordance with claim 1, wherein said acidified solution is maintained in the temperature range between 25 and 100 degrees centigrade.

5. The method of preparing glycoluril slow release fertilizer suspension in accordance with claim 1, wherein the pH of the mixture is adjusted to between 1.0 and 7.2.

6. The method of preparing glycoluril slow release fertilizer suspension in accordance with claim 1, wherein a liquid fertilizer is formed containing one or more nitrogen, phosphate or potassium nutrients.

7. The method of preparing glycoluril slow release fertilizer suspension in accordance with claim 1, wherein the water content of the aqueous solution is adjusted by the addition of water to meet a solids content of a composition comprising N—P—K nutrients.

8. The method of preparing glycoluril slow release fertilizer suspension in accordance with claim 1, wherein said admixing a suspending agent with said particles in the amount of between 0.5 and 1.5 percent.

9. The method for preparing glycoluril slow release fertilizer suspension in accordance with claim 7, maintaining a pH around 1.0 with necessary mixing to yield a final composition that can be stored while the glycoluril forms with suspension at room temperature.

10. The method of preparing glycoluril slow release fertilizer suspension for liquid application to a lawn or as a component of a granulated fertilizer turf product, comprising:
Mixing between 2 and 8 moles of urea per mole of glyoxal, for forming an aqueous urea and glyoxal solution;
adding between 10 and 30 percent by formula weight of the mineral acids, for acidifying the aqueous solution one or more mineral acids selected from a group of hydrochloric, phosphoric, nitric or sulfuric acid;
maintaining the temperature between 25 and 100 degrees centigrade, for heating the acidified solution until more than 70 percent of the glyoxal has reacted for form water insoluble glycoluril particles;
adjusting the mixture between 1.0 and 7.2 pH, for admixing a base selected from the group consisting of ammonia, alkali metal hydroxides and alkali metal carbonates;
creating a liquid fertilizer containing one or more: nitrogen, phosphate and potassium plant nutrients, for admixing principal fertilizer materials such as the ammonium and potassium salts, urea, nitrate salts, phosphate salts, and other plant nutrients with the glycoluril particles and adjusting the water content of the aqueous solution;
adding between 0.5 percent and 1.5 percent of a suspending agent, for suspending the glycoluril and plant nutrients; and
mixing the components of the fertilizer formula, maintaining a pH around 1.0 and adding a suspending agent with necessary mixing to yield a final composition that can be stored while the glycoluril forms with suspension at room temperature, for preparing a formulation at room temperature.

11. A method of producing storage stable glycoluril slow release fertilizer suspensions, the steps comprising:
mixing between 2 and 8 moles of urea per mole of glyoxal in water to form an aqueous solution; and
acidifying the aqueous solution with between 10 to 30 percent by weight of one or more mineral acids selected from the group of hydrochloric, phosphoric, nitric or sulfuric acids.

12. The method of claim 11 wherein the acidified solution is held at a temperature between 25 and 100 degrees Centigrade until 70 percent or more of the glyoxal has reacted sufficiently with the urea to form water insoluble glycoluril particles and the aqueous mixture of glycoluril particles is neutralized to a pH between 6.0 and 7.2 by admixing a base selected from the group consisting of ammonia, alkali metal hydroxides and alkali metal carbonates.

13. The method of claim 11 wherein one or more nitrogen, phosphate and potassium plant nutrients are admixed with the glycoluril particles and the aqueous solution to form a complete liquid fertilizer.

14. The method of claim 11 wherein a suspending agent amounting to between 0.5 and 1.5 percent by weight is added to the glycoluril slow release formulation.

15. The method of stimulating turf growth by applying the composition of claim 14 to a lawn care surface as a liquid or a component of a granulated fertilizer.

16. The method of claim 11 wherein the acidified solution is maintained at a temperature between 25 and 100 degrees Centigrade until 70 percent or more of the glyoxal has reacted sufficiently with the urea to form water insoluble glycoluril particles and one or more nitrogen, phosphate and potassium plant nutrients are admixed with the glycoluril particles and the aqueous solution to form a complete liquid fertilizer.

17. The method of claim 16 wherein a suspending agent amounting to between 0.5 and 1.5 percent by weight is added to the glycoluril slow release formulation.

18. The method of stimulating turf growth by applying the composition of claim 17 to a lawn care surface as a liquid or a component of a granulated fertilizer.

19. The method of claim 11 wherein the acidified solution at room temperature is mixed with one or more nitrogen, phosphate and potassium plant nutrients, suspending agent is incorporated at an amount to between 0.5 and 1.5 percent by weight and the glycoluril slow release particles are allowed to form at room temperature in storage tanks or containers to yield the desired fertilizer formulation.

20. The method of stimulating turf growth by applying the composition of claim 19 to a lawn care surface as a liquid or a component of a granulated fertilizer.
